(19) United States
(12) Patent Application Publication
(10) Pub. No.: US 2026/0170597 A1
(43) Pub. Date: Jun. 18, 2026

(54) Ray Management

(71) Applicant: Imagination Technologies Limited, Kings Langley (GB)

(72) Inventors: Panagiotis Velentzas, Hertfordshire (GB); Arun Demeure, London (GB)

(21) Appl. No.: 19/395,954

(22) Filed: Nov. 20, 2025

(30) Foreign Application Priority Data
Nov. 22, 2024 (GR) 20240100836
Dec. 10, 2024 (GB) 2418067.1

(51) Int. Cl. G06T 1/20; G06T 1/60

(52) U.S. Cl. CPC G06T 1/20; G06T 1/60

(57) ABSTRACT

A processor has a processing module a ray engine. The ray engine comprises a ray store and ray-tracing circuitry. The ray-engine comprises control logic which: receives a plurality of batches of ray descriptors supplied from the processing module, each batch comprising respective ray descriptors of a plurality of modelled rays; and allocates ray descriptors to address space of the ray store in blocks of ray descriptors, each block being a subset of the ray descriptors in the batch, and stores each block in the allocated address space. For each batch of ray descriptors, the ray-tracing circuitry processes each of the rays of the batch based on the respective ray descriptors stored in the ray store. For each block, the control logic deallocates the memory allocated to the block in response to the processing of all the rays in the block being finished by the ray-tracing engine.

### CROSS-REFERENCE TO RELATED APPLICATIONS AND CLAIM OF PRIORITY

This application claims foreign priority under 35 U.S.C. 119 from Greece patent application No. 20240100836 filed on 22 Nov. 2024 and United Kingdom patent application No. GB 2418067.1 filed on 10 Dec. 2024, the contents of which are incorporated by reference herein in their entirety.

### TECHNICAL FIELD

The present disclosure relates to the management of the address space allocated to ray descriptors in a ray store.

### BACKGROUND

A processor is a device for executing a set of machine code instructions including various general-purpose instructions such as add, multiply, etc. An application-specific processor, such as a graphics processing unit (GPU), can be tailored to a specific application by including one or more dedicated hardware modules for performing one or more specific types of operation in fixed-function hardware circuitry. Such hardware may be invoked for example by one or more specialised instruction types in the instruction set of the processor, or by writing to dedicated registers or to a buffer in a dedicated region of memory, or such like, depending on the design of the processor.

Ray tracing (also called ray traversal) is one job which a graphics processor may be used to perform, either in software or dedicated hardware, or a combination. Ray tracing refers to a graphics processing technique for generating an image by tracing a path of light through a modelled environment and simulating the effects of its encounters with objects along the way. Modelled rays of light are traced from a modelled source to a modelled view point (forward ray tracing) or vice versa backwards from the modelled view point to the modelled source (i.e. reverse ray tracing, which is typically more efficient as forward ray tracing often results in processing rays whose trajectory ultimately never hits the viewpoint). A ray may be described by coordinates of an origin or endpoint of the ray, a vector specifying the direction of the ray, and typically a maximum and minimum extent of the ray along that vector, and optionally a ray colour. Ray tracing begins by casting rays out into the modelled environment, from each pixel in the image in the case of reverse ray tracing. Objects with which rays may interact in the modelled environment are divided into geometric primitives, e.g. triangular facets. For each ray, the ray tracing comprises finding the closest geometric primitive (if any) with which the ray interacts (a “hit”).

A bounding volume hierarchy (BVH) is a type of data structure that is used in ray traversal. The data structure of the BVH takes the form of a tree structure, in which nodes represent regions of space (typically boxes) in a modelled environment, and an edge from parent node to child node represents that the region represented by the child node is nested within the region represented by the parent. The nodes are thus arranged in hierarchical levels from a root node down to a leaf node at the lowest level of each branch. The region of space represented by each leaf node contains a respective one or more geometric primitives or at least part of a geometric primitive. The BVH is used in the ray traversal mechanism to search for geometric primitives with which a modelled ray intersects. The search comprises first determining which node the ray would traverse at the first level down from the root, and then determining which of that node's children the ray would intersect, and so forth, until the search ends with finding a leaf node traversed by the ray and determining whether the ray intersects with the primitive or any of the primitives contained within that leaf node. Other types of ray traversal structure are also known (also called acceleration structures).

In some graphics processors this search is performed in fixed-function hardware. In general the ray tracing may be performed in software using general-purpose instructions, or in dedicated hardware, or in a combination of these

When an incident ray is found to intersect a geometric primitive, then the effect of the intersection in terms of light level and colour is to be determined. Also, when a ray intersects, it can then either terminate, reflect or refract. A reflection or refraction introduces one or more secondary rays with a new direction relative to the incident ray, which is terminated (i.e. the reflected or refracted ray is modelled as a new ray). The secondary rays may also accumulate a new value (e.g. colour and/or intensity) relative to the incident ray. Determining such effects of an interaction of a ray with a geometric primitive is typically solved analytically in software, often referred to as a shader, or shader software.

In a known GPU design, the GPU comprises i) a processing module comprising one or more executions units that execute(s) the shader software, and ii) a hardware ray engine (also called a “traversal unit”) which comprises dedicated hardware circuitry for performing ray tracing. By way of example, in one particular known design the processing module is referred to as the USC (unified shader cluster) and the ray engine is referred to as the RAC (ray acceleration cluster). The shader software run on the processing module forms a bounding volume hierarchy (BVH) that divides the modelled environment into hierarchical regions for search purposes, as discussed above. The shader software writes the BVH to a location that is readable by the ray engine. The shader software also sends ray descriptors to the ray engine for processing in hardware by the ray engine (note therefore that the term “processing” per se as used herein, particularly when used in relation to the processing of a ray by the ray engine, does not necessarily imply the execution of software). The ray engine uses the BVH and ray descriptors to test whether the modelled rays would intersect with geometric primitives in the modelled environment. The results of this are then sent back to the shader software on the processing module.

### SUMMARY

A ray engine comprises a ray store, which is a memory for storing the ray descriptors received from the processing module. In a memory, address space has to be allocated for use by a particular purpose such as a particular process or task, and needs to be deallocated again if it is to be reused for storing new data for a different process or task. In the case of a ray store, an issue with conventional arrangements is that the processing module bundles rays into batches, i.e. each task comprising a bundle of rays. Typically the software is divided into tasks (also called waves) with each batch of ray descriptors being generated, and allocated to the ray engine, by a corresponding one of the tasks. Conventionally each batch is treated monolithically for the purpose of memory allocation and deallocation. That is, the region of memory in the ray store allocated to the ray descriptors of a particular batch (assigned by a particular task) cannot by freed until all the rays of that batch have finished being processed by the ray engine.

This can lead to stalls. For instance, as a simple example, consider a case where the batch of each task is 128 rays, and the ray store can hold up to a maximum of 256 ray descriptors (in practice the ray store may be larger than this, and other batch sizes may be used, but this example will serve to illustrate the principle). Once the batches of two tasks are assigned to the ray engine by the processing module, the ray store is full and since ray batches are treated monolithically, a batch belonging to a third task cannot be assigned to the ray engine until an entire one of the first and second batches has been completed by the ray engine, and its memory space deallocated. Further, different rays in a given batch will take different amounts of time to complete, due to different amounts of time to traverse the BVH (or other such acceleration structure) in order to find an intersection. E.g. some rays may find an intersection only a few levels deep into the BVH, while others may have to explore many levels (the leaves of the tree are not necessarily all at the same level). See the schematized example of FIG. 3 by way of illustration, to be discussed in more detail later. Thus a batch of rays may take a long time to complete, even though a majority of the rays of the task may have finished some time ago (many processor cycles earlier), and the assignment of a new batch from a new task to the ray engine is stalled awaiting the last few rays of one of the existing tasks to finish.

To address this, the present disclosure provides a processor in which the rays of a given batch (e.g. generated by a given task) are subdivided into blocks, and memory space in the ray store is allocated and de-allocated on a per-block basis.

According to one aspect disclosed herein, there is provided a processor comprising a processing module, the processing module comprising a register file and processing apparatus, the processing apparatus comprising one or more execution units, wherein the processing apparatus is arranged to execute software and thereby operate on values held in the register file. the processor further comprises a ray engine comprising a ray store and ray-tracing circuitry, wherein the ray store is implemented in memory that requires address space to be allocated for use and de-allocated to allow re-use. The ray-engine further comprises control logic arranged to receive a plurality of batches of ray descriptors supplied from the processing module, each batch comprising respective ray descriptors of a plurality of modelled rays, and to allocate ray descriptors to address space of the ray store in blocks of ray descriptors, each block being a subset of the ray descriptors in the batch, and store each block in the allocated address space. For each batch of ray descriptors, the ray-tracing circuitry is configured to perform processing of each of the rays of the batch based on the respective ray descriptors stored in the ray store and thereby generate respective hit results, the processing comprising ray-tracing. The control logic is configured, for each block, to deallocate the memory allocated to the block in response to the processing of all the rays in the block being finished by the ray-tracing engine.

This advantageously enables some of the memory of the ray store to be freed before an entire batch of rays (e.g. the batch of a given task) has completed, thus freeing up memory for tasks earlier than is possible in the conventional, monolithic case. For instance, consider again the illustrative example where the batch of each task is 128 rays, and the ray store can hold up to a maximum of 256 ray descriptors (again, in practice the ray store may be larger and other batch sizes may be used, but this is just to illustrate the issue). The block size could be, say, 8 or 16 rays. Initially, immediately after the batches of the first two tasks have been assigned to the ray engine by the processing module, the ray store is full and the rays of a third task cannot yet be assigned. However now, once enough blocks from the batches belonging to the first and second tasks combined have been completed and their memory space in the ray store deallocated (including the possibility of a combination of blocks from the batches of both tasks), then the batch of ray descriptors of a third task can be assigned to the ray engine even though neither one nor the other of the first and second tasks' batches has yet finished in its entirety.

More generally, if each batch corresponds to a range of ray IDs of N respective ray descriptors, the ray store can hold a maximum of M×N ray descriptors, each block is of size B ray descriptors, where M, N and B are integers greater than one; then the software arranged to run on the processing apparatus of the processing module may be configured so as, after M batches have been received by the ray engine for processing, to send a further batch when ray store still holds M unfinished tasks but k blocks are completed, where kB>=N, and k is an integer greater than one.

In embodiments the control logic in the ray engine may be configured to perform said receiving of the plurality of batches of ray descriptors by pulling each of the batches from the processing module. In some such embodiments, the control logic in the ray engine may be configured to perform said receiving of the plurality of batches of ray descriptors by pulling the ray descriptors of each of the batches from the register file of the processing module. Alternatively or additionally, the software arranged to run on the processing apparatus of the processing module is arranged to cause the control circuitry in the ray engine to perform said pulling, by the software comprising one or more instructions configured to: for each batch of ray descriptors, send to the control circuitry in the ray engine an indication of locations of source registers holding the respective ray descriptors of the rays of the batch in the register file of the processing module, thereby causing the control logic in the ray engine to record the locations of the source registers in a register map in the ray engine and pull the respective ray descriptors from the register file of the processing module, the control circuitry in the ray engine being configured to perform said pulling by pulling from the locations of the source registers as recorded in the register map.

In embodiments, the control logic in the ray engine may be configured so as, for each block, to send the hit respective results of the rays of the block to the processing module. In some such embodiments, The control logic in the ray engine may be configured to perform said sending by storing the respective hit results in the register file of the processing module. In particular embodiments like this, the control logic in the ray engine may be configured to perform said storing by pushing the respective hit results to the register file in the processing module.

In embodiments, the one or more instructions may be further configured to send, to the control circuitry in the ray engine, an indication of locations of respective destination registers in the register file for receiving the hit results of the rays of the respective ray descriptors; and the control circuitry in the ray engine is configured to record the locations of the destination register in the register map, and perform said sending by sending the hit results to the respective destination registers. In embodiments, said one or more instructions comprise a single machine code instruction per batch of ray descriptors.

In embodiments, the control circuitry in the ray engine may be configured as a master to the processing module (at least for the stated purposes).

In embodiment, the software arranged to execute on the processing module may comprise a plurality of tasks, each being configured to supply a corresponding one of the batches of ray descriptors to the ray engine. In some such embodiments, each task may be configured to enter a dormant state after supplying its corresponding batch to the ray engine, and to wake up again and process the respective hit results of the batch in response to a completion signal from the control circuitry of the ray engine signalling that the processing of all the rays in the batch has been completed.

In embodiments, the control circuitry in the ray engine may be configured to: determine when the ray store is unable to accommodate any further batches, and in response pause the processing of any further batches of ray descriptors; and determine when enough blocks have subsequently been freed to accommodate a further batch, and in response to process at least one further batch of ray descriptors.

In embodiments, the control circuitry in the ray engine may be configured such that the blocks are of configurable or programmable size.

In embodiments, each ray descriptor has a respective ray ID, and each block may be a subset of the descriptors with contiguous ray IDs.

In embodiments, the ray-tracing circuitry may be fixed-function ray-tracing hardware. The processor may be embodied in hardware on an integrated circuit. There may be provided a method of manufacturing the processor at an integrated circuit manufacturing system. There may be provided an integrated circuit definition dataset that, when processed in an integrated circuit manufacturing system, configures the system to manufacture the processor. There may be provided a non-transitory computer readable storage medium having stored thereon a computer readable description of the processor that, when processed in an integrated circuit manufacturing system, causes the integrated circuit manufacturing system to manufacture an integrated circuit embodying the processor.

There may be provided an integrated circuit manufacturing system comprising: a non-transitory computer readable storage medium having stored thereon a computer readable description of the processor; a layout processing system configured to process the computer readable description so as to generate a circuit layout description of an integrated circuit embodying the processor; and an integrated circuit generation system configured to manufacture the processor according to the circuit layout description. The layout processing system may be configured to determine positional information for logical components of a circuit derived from the integrated circuit description so as to generate the circuit layout description of the integrated circuit embodying the graphics processing system.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

This Summary is provided merely to illustrate some of the concepts disclosed herein and possible implementations thereof. Not everything recited in the Summary section is necessarily intended to be limiting on the scope of the disclosure. Rather, the scope of the present disclosure is limited only by the claims.

### BRIEF DESCRIPTION OF THE DRAWINGS

Examples will now be described in detail with reference to the accompanying drawings in which:

FIG. 1 shows a processor comprising a shader engine and a ray engine,

FIG. 2 shows a modified processor according to embodiments of the present disclosure,

FIG. 3 shows an example distribution of competed rays,

FIG. 4 is s flow chart of a method performed by a modified ray engine in accordance with embodiments disclosed herein,

FIG. 5 shows a computer system in which a graphics processing system is implemented; and

FIG. 6 shows an integrated circuit manufacturing system for generating an integrated circuit embodying a graphics processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

The present disclosure discloses a system and method of dynamic ray-management, which in embodiments is based on a pull-push mechanism of communication.

Code divergence in a task (also called a wave) results in low ray tracing utilisation (some threads do ray tracing, others don't) and incoherent rays cause wave execution time that is being dragged down by just a few very slow rays (aka long tails or skewed distribution of thread execution times). In the first case, one ends up with wasting ray resource allocations for threads that do not do ray tracing and in the later case many tasks find themselves idle for long periods of time.

The former is not a big problem for architectures with small sized waves and also for content that does a lot of ray tracing (e.g. desktop RT games). For the later API extensions have been proposed that interrupt the wave execution after a predetermined time. This means that some threads have not finished tracing and have incorrect intersection results. It is then up to the application to reject or accept these results or retry those rays.

The present disclosure addresses the first problem by allowing smaller blocks of rays to be allocated and later by freeing those blocks when they finish traversal so others can make use of them. The task itself will still have to wait until all rays return before resuming execution. The difference is that now ray deallocations can be done early and offload the ray results to the shading engine for when the wave resumes.

Thus the disclosed techniques allow early and partial deallocation of a task's ray resources by offloading the ray results as soon as a block of rays finishes traversal. In embodiments ray allocations may also be configurable in size (block size, task batch size, and/or the size of the ray store may be configurable) In the process of achieving this goal, in embodiments the ray tracing operation has become completely independent and all the shading engine has to do is kick a trace, go to sleep and wait to be waken up when a task's worth of traversal has finished. The kick has also been reduced to a simple compound instruction. The ray traversal logic does not require any input from the shading engine besides a kick. It is envisaged that the pull-push operation of the ray tracing unit described herein (i.e. pull ray description, push intersection results) may become integral in a move to hardware accelerated ray traversal.

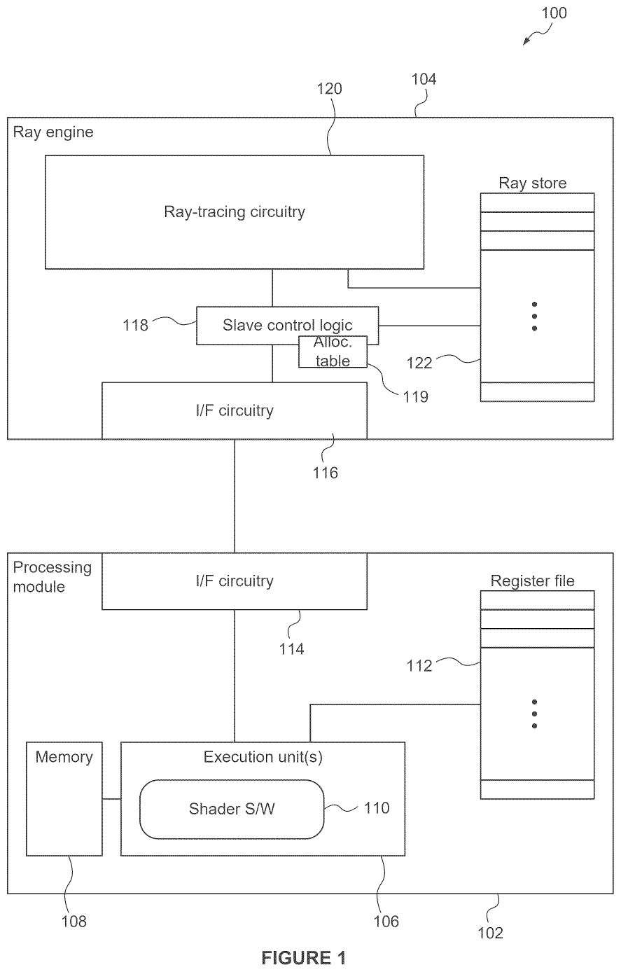

FIG. 1 is a schematic block diagram of a processor 100 with a conventional arrangement between processing module and ray engine. The processor 100 comprises a processing module 102 and a ray engine 104. The processing module 102 could also be referred to as a shader engine or shading engine in that it executes shader software (though does not necessarily exclusively execute shader software). For example, in one example implementation the processing module 102 may take the form of a unified shader cluster (USC), and the ray engine 104 may take the form of a ray acceleration cluster (RAC).

The processing module 102 comprises processing apparatus 106 comprising one or more execution units which are operable to execute program code (i.e. software). The processing module 102 further comprises memory 108, a register file 112, and interface circuitry 114 for interfacing with the ray engine 104. The processing apparatus 106 comprises one or more execution units, e.g. cores, pipelines, lanes, etc., which may be implemented in the same die or IC package or different dies or packages, or a combination. The memory 108 of the processing module 108 may be referred to herein as the shader-side memory, or just the memory of the processing module 102, to distinguish it from the ray store 122 (discussed later). However this terminology is not intended to limit to any particular type or arrangement of memory.

The processor-side memory 108 comprises program memory which stores program code to be executed on the processing apparatus 106. The program code comprises at least shader software 110. The program memory is typically implemented in read-only memory (ROM), and resides externally in DRAM (dynamic random access memory), but more generally the program memory could be implemented in any one or more types of memory or memory devices. The processor-side memory 108 may also comprise memory used to store program data to be loaded and operated on by the program code, and/or to store program data resulting from the program code. In embodiments this data memory may be separate from the program memory and typically at least some of it may be implemented internally to the same die or IC package as the processing apparatus, but more generally the data memory can be implemented in any one or more internal or external memory types or devices, either in one or more separate memory devices than the program memory, or in a different region or regions of one or more of the same devices as the program memory, or a combination. Some instructions of the program might contain ‘immediate data’ that can be used by the operation performed by the instruction. The processor-side memory 108 may be implemented in one or more memory units internal and/or external to the same die(s) or package(s) as the processing apparatus 106. The memory 108 may employ one or more memory types and/or memory media, e.g. ROM (read only memory), bulk storage such as a hard drive (HDD) or solid state drive (SSD), RAM (random access memory) such as DRAM (dynamic RAM) or SRAM (static RAM), EEPROM (electrically erasable and programable ROM) such as flash memory, or a magnetic disk or tape, etc.

The register file 112 comprises a set of registers arranged to hold values to be operated on by the program code when executed on the processing apparatus 106. These may include values loaded from the program memory 108. They also include values received from the ray engine 104, as will be discussed in more detail shortly. The register file may be implemented in one or more register banks at one or more locations within the processor 100. The register file 112 is faster on-chip memory than the memory 108, and most of the input/output operands of an instruction are usually read/written from/to there. In the case of a USC, the register file 112 may also be referred to as the unified store.

Note that a processing “module” as referred to herein most generally can refer to any subsystem comprising memory, registers, one or more execution unit(s), and any necessary interfacing circuitry. It does not necessarily imply that the processing module 102 is indivisible or self-contained, nor that it forms part of a processor or wider system that can be assembled in a modular fashion, or the like. Nor does it necessarily imply that all the components of the module 102 are necessarily implemented in the same die or IC package, though in embodiments they may be. The processing module 102 could also be referred to as a processing subsystem, processing engine or shader engine (in that it runs shader software), for example.

The processing module 102 may comprises various constituent components such as parallel execution units for float or int for example, as well as scheduling logic, register file routing logic, instruction fetch and decode logic, etc. In embodiments the processing module 102 may be referred to as a cluster, such as a USC, in that it can be instantiated multiple times within a larger unit, e.g. as cores in a multi-core system. For example two, three or four USCs can be instantiated in a unit called a SPU (scalable processing unit). SPUs themselves may also be instantiated multiple times to make up the whole system along with some other peripheral modules. The design of GPUs may employ this “core” concept to allow putting down more of these cores to scale performance up and create higher-end products for customers.

The ray engine 104 comprises ray-tracing circuitry 120, slave control logic 118, a ray store 122, and interface circuitry 116 for interfacing to the processing module 102 (via the interfacing circuitry 114 of the processing module 102). The ray store 122 is operable to store ray descriptors received from the processing module 102, as will be discussed in more detail shortly. Each ray descriptor comprises parameters of a respective ray being modelled. The ray-tracing circuitry 120 is configured to perform ray tracing of the rays based on their ray descriptors as held in the ray store 122. The ray-tracing circuitry 120 is preferably implemented wholly or in part in dedicated hardware, e.g. fixed-function hardware, or dedicated hardware with some degree of configurability but which does not work by executing general purpose code from memory. Alternatively is not excluded that ray-tracing circuitry 120 could be implemented partially or wholly in some form of dedicated execution unit or units which executes code, e.g. firmware.

The slave control logic 118 is arranged to receive the ray descriptors from the register file 112 on the processing module, under control of the shader software 110, via the interface circuitry 114, 116; and to allocate address space in the ray store 122 in which to store the ray descriptors. This will be discussed in more detail shortly. The slave control logic 118 may be implemented in dedicated hardware circuitry, e.g. fixed function circuitry or configurable hardware. Alternatively a small microcontroller running embedded software, such as firmware, or combination of these approaches, is not excluded.

Note that a ray “engine” as referred to herein can refer generally to any subsystem comprising ray-processing circuitry, ray store and control logic. The ray engine could also be called a ray accelerator or ray processing module (not necessarily implying that it is indivisible or part of a module design). The term “engine” does not necessarily imply any particular form of ray processing module. Also the term “processing” does not necessarily imply the execution of software unless stated. Particularly, in the case of the ray engine, the processing of the rays may be implemented in hardware.

In embodiments, the ray engine 104 may be referred to as a cluster, e.g. the RAC, in that, similarly to the USC, it can be instantiated multiple times to enable scaleability.

In operation, the processing apparatus 106 of the processing module 102 executes the program code from the program memory that is part of the processor-side memory 108. This processor code includes the shader software 110. When executed, the software may write an acceleration structure (ray acceleration structure) such as a BVH or other hierarchical search tree to a storage location (not shown) accessible to the ray-tracing logic 120 of the ray store 104.

Alternatively the acceleration structure could be provided to the ray engine 104 from another source. The shader software 110 also passes ray descriptors to the ray engine 104. To do this, it writes the ray descriptors to registers in the register file 112 on the processing module, then (conventionally) executes individual instructions to signal to the slave control logic 118 on the ray engine 104 (via the interface circuitry 116, 118) instructing it to retrieve each ray descriptor, allocate corresponding address space in the ray store 122, and store the ray descriptor in the allocated address space in the ray store 122. Thus, conventionally, the software on the processing module 102 takes each ray descriptor from the register file 112 and pushing them to the ray engine 104. The ray store 122 is typically implemented as RAM. It may comprise one or more RAM units. Alternatively other forms of memory are not excluded.

The ray-tracing circuitry 120 in the ray-engine 104 is configured to take the ray descriptors from the ray store 122 and perform ray traversal (ray tracing) in order to find an intersection (typically the closest intersection) of a ray with the modelled environment. It does this based on the ray descriptor and the BVH (or other such acceleration structure), as stored in the relevant storage location, which describes the modelled environment for search purposes. For each detected intersection, the ray-tracing circuitry 120 produces hit information which the shader software run on the processing module 110 will retrieve back into the register file 112 (or alternatively the hit information for a given ray could indicate that no hit was detected). Based on this hit information, the shader software 110 on the processing module 102 performs corresponding shading operations. The shader may also cast more rays, which in turn are sent to the RAC for further ray traversal, etc. (so shader A may call shader B, which in turn calls shader C, etc.).

Each ray descriptor comprises parameters of the ray, such as ray origin or endpoint, ray direction, ray extents Tmin/Tmax, and perhaps other information such as any ray flags, hit-object indices and/or barycentrics, etc. Each ray also has an associated ray descriptor which is typically generated by the control logic 108. The ray ID is a location (i.e. address) of the ray in the ray store 122. The address in the ray store could also be described as a line or entry in the ray store 122.

The shader software 110 on the processing module 102 assigns ray descriptors (and thus the rays they model) to the ray engine 104 in batches, e.g. of 128 rays per batch. Typically the shader software 110 is divided into portions called (also sometimes “waves”), whereby each task is responsible for a corresponding one of the batches of rays. That is, each task is responsible for generating the ray descriptors of a given batch, assigning them to the ray engine 104, and processing the results once available from the ray engine 102. Each task may comprise a plurality of threads, wherein each thread is responsible for generating the ray descriptor of a respective one of the rays and processing the result of the respective ray. Different threads may be executed in parallel via different parallel lanes (e.g. SIMD lanes) of the processing apparatus 106. A thread may also be referred to as an instance.

For each batch of ray descriptors, the shader software 110 (e.g. the respective task) includes instructions to write each of the ray descriptors in the batch to the ray store 122, in the manner as discussed above (though in some cases some of the descriptors in the batch could be undefined—the task thread that was supposed to create the descriptor data didn't because it determined not to cast a ray). A given task as a whole has an ID called the primary task ID.

For speed, typically the interface circuitry 114, 116 forms a direct interface between the processing module 102 and ray engine 104 (rather than going via a general purpose bus or the like, or via a shared memory such as an external memory like a DRAM, etc.). The shader software 110 sends the ray descriptors to the ray engine via the direct interface 114, 116.

Memory address space in the ray store 122 has to be dynamically allocated for use in storing the ray descriptors of a given batch belonging to a given task (the ray store is a memory so there is a memory allocation mechanism), and de-allocated again after use if it is to be re-used by another batch of another task. Conventionally this allocation is performed by the slave control logic 118 on the ray engine 104 under control of the shader software 110 (e.g. the respective task) run on the processing module 102 (via signalling over the interface 114, 116). The allocation is recorded in a memory allocation table 119 in the ray engine 104, which records, for each for a plurality of addresses or address ranges within the memory of the ray store 122 (i.e. for each of a plurality of units of address space), whether that address or address range is currently allocated, and if so for which task. Thus each address or address range (each unit of address space) can be claimed or “spoken for” by a given task (i.e. for use in storing the ray descriptors of a given task), and must be claimed by a task to be used for that task, and cannot be used by any other task until freed again (de-allocated). This table 119 may be implemented as a bit-vector associated with each unit of address space, with each bit mapping to a primary task ID that records whether the use if address space is in use by the corresponding task at the moment or not.

The ray-tracing circuitry 120 of the ray engine 104 is arranged to take ray descriptors from the ray store 122, and to process each in order to perform the ray tracing of the respective modelled ray. In embodiments, the ray-racing circuitry 120 may be configured to process multiple rays in parallel. The parallelism may be implemented as a form of multi-threading. The ray-tracing circuitry 120 has a pipeline that prepares and performs intersections. A new work batch is pumped to this pipeline every few clocks so at different stages of the pipeline, there can be different work batches.

A primary task ID maps to a range of N consecutive ray IDs (where N is an integer greater than one, e.g. 128). So for example ray ID range 0 to 127 belongs to primary task ID 0, and ray ID range 128 to 255 belongs to primary task ID 1, etc. If it is desired to find out which primary task ID a ray maps to, its ray ID can be divided by 128.

Note: a given batch of rays (from a given task) does not necessarily have to include a full complement of rays. A task batch has a nominal size of N ray descriptors, i.e. a capacity of up to N rays (where N is an integer greater than one, e.g. 128). Another way to put this would be to say the batch can accommodate N entries, each corresponding to a respective ray ID of a ray or potential ray; or that a batch corresponds to a range of N ray IDs. However the batch of any given task may actually comprise fewer than N ray descriptors. Thus some of the potential entries in the batch (i.e. some of the ray ID positions in the range of ray IDs belonging to the batch) may be “empty” or undefined, so there is not necessarily one actual ray per ray ID in a task. For such ray IDs, the ray-store field in the ray store 104 will not been written by the corresponding task thread (instance).

Nonetheless the memory space in the ray store 122 still gets allocated for the full range of N ray IDs. But the processing module 102 does not write ray descriptor for “empty” Ray IDs. Therefore some ray IDs do not actually cast a ray. It is up to the shader program 110 (e.g. the respective thread of the task) to determine which ray IDs in the range of a given task are used.

The ray-tracing circuitry 120 writes the results of the ray tracing back to the ray store 122 (when space is allocated in the rays true for each ray, then respective space is allocated for the respective result as well as just the respective ray descriptor). When the ray-tracing circuitry 120 has finished processing all the threads in a given batch, the slave control logic 118 sends a signal to the processing module 102 (somewhat like an interrupt) to wake up the relevant software 110 (e.g. the corresponding task), which then reads the all the hit information of the batch back from the ray store 122 to the register file 112 in the processing module 102, via the interface circuitry 114, 116 (e.g. a direct interface). The shader software 110 (e.g. the relevant task) can then operate on the contents of the registers 112, as operands stored in the registers of a processor.

An issue with the above arrangement is that typically many processor cycles of the processing apparatus 106 elapse between a batch of rays being assigned to the ray engine 104 and any given ray of the batch being completed (i.e. when an intersection is found). Further, different rays will take different times to finish being processed by the ray-tracing circuitry 120—the time depends (at least in part) on how many levels of the hierarchy of the ray traversal tree it has to traverse in order to find the intersection (there may be other conditions that might make the traversal faster than that, but nonetheless the number of tree levels or steps is a good proxy as an indication of traversal time). Each level of the tree that needs to be traversed incurs of the order of 1000 processor clock cycles. Further, some threads may not even cast a ray.

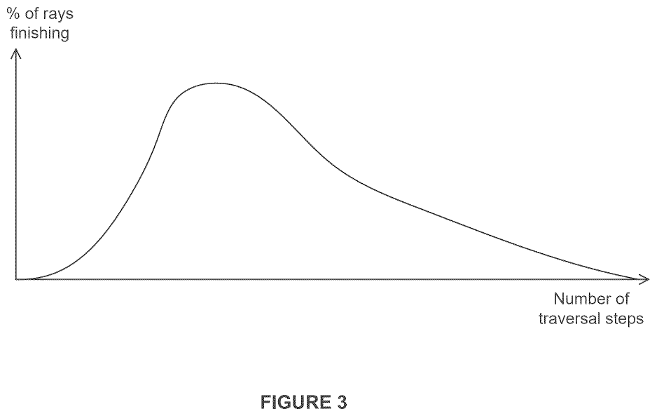

This results in a “long tail” in the distribution of completed rays vs. traversal steps (or time). The shape of the distribution is that of a positively skewed bell curve or similar. See the schematized example of FIG. 3 by way of illustration.

Because descriptors are allocated and deallocated on a per batch basis (“monolithically”), with the space in the ray store only being deallocated for the batch as a whole once the whole batch has been completed, then the system has to wait for the whole batch (e.g. the batch of a whole task) to be finished before any of the space in the ray store taken up by the whole batch of ray descriptors can be freed up for use by another batch (e.g. that of another task).

For instance, the fastest rays may be done in ˜1000 cycles, and most (say ˜99%) may be done within ˜5000 cycles, while the last few slowest (e.g. the last 1%) may take ˜10,000s of cycles (where “˜” means “of the order of”). So the storage in the ray store for the whole batch of ray descriptors is clogged up for many cycles waiting for the last 1% of threads in the task to complete.

This may result in the system stalling, unable to allocate more batches of rays (e.g. from more tasks) as the ray store 122 is full waiting for tasks to be completed so the corresponding space in the ray store can be freed (deallocated). E.g. for the sake of illustration, say that each batch is 128 ray IDs and the ray store has space for 256 ray descriptors, i.e. two tasks' worth (in practice it may be able to accommodate a larger number of batches, e.g. 3K to 6K rays, but this example will serve to illustrate the principle). The shader software 110 on the processing module 102 can allocate a first and second task to the ray engine 104, and then has to wait until a whole one of the two respective batches has completed before it can allocate a third batch (of a third task).

The effect is more pronounced if the rays are incoherent, e.g. go in diverse or random directions such as with global illumination such as AO (ambient occlusion) rays. Incoherent rays in a batch can also have ray origins that are far away from each other even if their directions are similar. In effect incoherent means that they follow substantially different traversal paths along the tree (i.e. their paths diverge quickly as the rays descend the tree of the acceleration structure, e.g. BVH).

To address this, instead of the above, the present disclosure provides an arrangement which is able free “blocks” of ray descriptors in the ray store, which are smaller in size than the batch-size of in which they are allocated (e.g. the batch size as allocated by a given task, i.e. batch size per task). For instance if a batch is 128 ray descriptors (and a task is up to 128 threads), a block could be, say, 8 descriptors. Preferably a block is a block of contiguous ray IDs, i.e. a contiguous subrange of the batch task. When the ray engine has completed processing the rays for a block of ray descriptors, it deallocates the block in the ray store 122, and pushes the hit results back to the shader software 110 on the processing module 102. It does this without having to wait for the processing (at least the traversal) of all the rays in the task to finish (except of course that for the last block in the batch, the end of the block is also the end of the batch).

Consider again the above example of batch size of 128 per task, and a ray store size of 256, but now also with a block size of 8 (for example). Two initial batches are allocated by two corresponding tasks, filling the ray store 122. Then after 16 blocks of 8 have been freed from the batch of either task (including the possibility of a combination of blocks from the batches of both tasks—some from one and some from the other), then now there is enough space freed to allocate a third batch from a third task. Thus the ray engine can begin processing a third task's batch of rays before either of the first and second are completed.

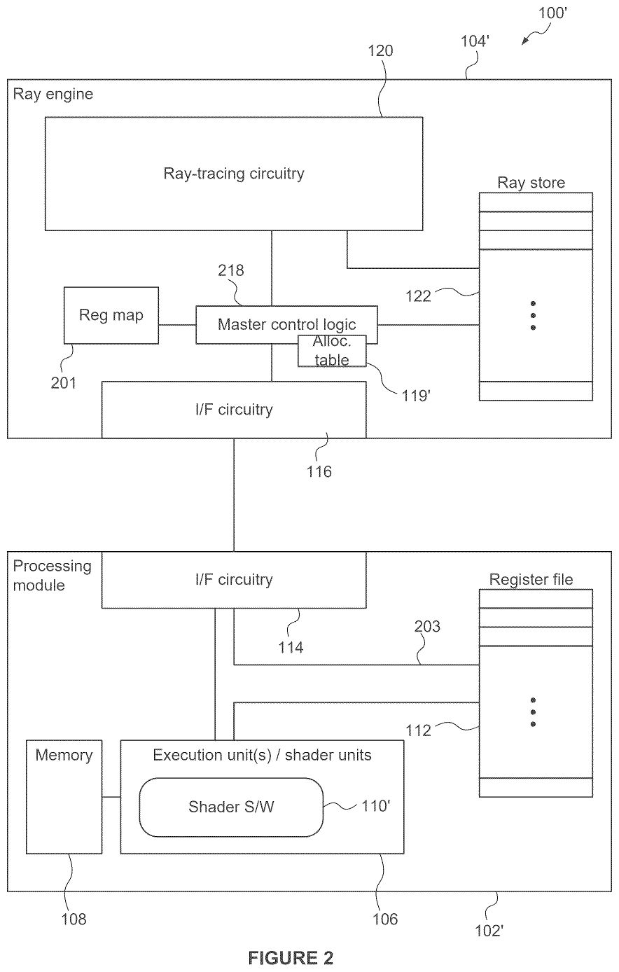

This will involve some modification to the relationship between the ray engine and the processing module 102 to implement. Such a modified arrangement in accordance with embodiments of the present disclosure is shown in FIG. 2.

In the conventional arrangement, the processing module 102 (e.g. USC) is the master and the ray engine 104 (e.g. RAC) never initiates any transfer or command. The processing module 102 executes instructions to write each individual ray descriptor to the ray store 122. When the ray engine 104 has completed a whole task, it merely sends a signal a bit like an interrupt back to the processing module 102, and the shader software 110 on the processing module 102 reads the results from the ray engine 104, at the initiation of the shader software 110 on the processing module 102. Whereas in the new arrangement, the shader software 110′ on the processing engine 102′ one or more instructions which tell the ray engine 104′ the source registers and the destination registers to use in the register file 112 of the USC, the indicated source registers being those in which the relevant ray descriptors are held, and the destination registers being the locations to return the respective results to. In embodiment this is done by executing a single “uber instruction” of the shader software 110′ per batch (e.g. per task). The ray engine 104′ then allocates the space in the ray store 122, in blocks, and initiates a read from the source registers in the register file 112 of the processing module 102′ (i.e. pulls from the processing module 102′).

Once the rays of a block are all done (have finished traversal), the ray engine 104′ deallocates the block in the ray store 122 and sends the hit results to the destination registers in the register file 112 of the processing module 102′, again at the initiation of the ray engine 104′ (i.e. it pushes to the processing module 102′). Hence this may be referred to as a “pull-push” mechanism from the perspective of the ray engine 104′ (i.e. to initiate the read/write to/from the processing module 102′). The new arrangement has changed who is the master.

To implement this, the ray engine 104′ may be provided with new, semi-autonomous controller logic 218 to implement this pull-push functionality. It is also provided with some storage 201 to hold the register IDs so the source and destination registers of the processing module's register file 112. This may be implemented as a local RAM-based store.

FIG. 2 shows a modified processor 100′ in accordance with embodiments of the present disclosure. The components of the processor 100′ are the same as the processor 100 of FIG. 1 and operate in the same way, except where indicated otherwise below. Therefore for the sake of conciseness, common components will not be discussed again at length.

The processor 100′ of FIG. 2 comprises a modified ray engine 104′ in place of the ray engine 104 of FIG. 1. Like the ray engine 104 of FIG. 1, the modified ray engine 104′ comprises ray-tracing circuitry 120, a ray store 122 and interface circuitry 116. These may be the same or substantially the same as described in relation to FIG. 1. Like the control logic 118 in the ray engine 104 of the processor 100 of FIG. 1, the ray engine 104 in the processor 100′ of FIG. 2 comprises control logic 218 for allocating memory address space in the ray store 122 to batches (e.g. of specific tasks), and storing the ray descriptors of a batch in the allocated space in the ray store 122. However, unlike the slave control logic 118 of FIG. 1 which acts purely as a slave under control of the shader software 110, in embodiments the control logic 218 of FIG. 2 may be configured to act, at least in some respects, autonomously and as a master to the processing module 102. Hence it may be referred to as the master control logic. The master control logic 218 may be implemented in dedicated hardware circuitry, e.g. fixed function circuitry or configurable hardware. Alternatively a small microcontroller running embedded software, such as firmware, or combination of these approaches, is not excluded.

The modified ray engine 104′ also comprises a register map 201, which will be described in more detail shortly. This may be implemented as a local RAM-based store. In some embodiments it could be implemented in an existing RAM that already exists for holding other information for the task (e.g. such storage may keep per task: the primary task ID allocated to it, a type of the task, and/or information about how to wake the corresponding task on the processing module 102).

The processor 100′ of FIG. 2 also comprises a processing module 102′ in place of the processing module 102 of FIG. 1. The processing module 102′ of FIG. 2 comprises processing apparatus 106, program memory 108, a register file 112 and interface circuitry 114, which may be the same or substantially the same described in relation to FIG. 1. This is therefore very similar to the processing module 102 of FIG. 1, except that in embodiments, it may comprise a modified path 203 between the interface circuitry 114 and the register file 112 that allows the master control logic 218 to write autonomously to the register file 112 (via the interfaces 114, 116). The shader program 110 may also be adapted to compliment the modified ray engine 104′.

In operation, in embodiments the shader software 110′ on the processing module 102′ (e.g. a given task of the software) may supply the ray descriptors of a batch (e.g. those generated by the corresponding task) to the ray engine 104′ in a modified fashion: rather than pushing the ray descriptors individually to the slave control logic 118 on the ray engine 104, the shader software 110′ (e.g. task) sends an indication of the locations of the ray descriptors in the register file 112 to the master control logic 208 on the ray engine 104′. This indication may be pushed from the processing module 102. I.e. the shader software 110′ on the processing module 102′ tells the master control logic 208 on the ray engine 104′ where it can find the ray descriptors in the register file 112 (which source registers to use). E.g. this may be done by sending a register address of the first ray of the batch of a given task in the register file, and the master control logic 208 of the ray engine 104′ knows the size of a task batch, so it can find all the ray descriptors of the task. Alternatively the shader software 110′ could simply send the register address of each individual ray descriptor, or the starting register address of each block, or such like. However this would be a slower implementation.

In assigning the batch, the shader software 110′ (e.g. the corresponding task) also indicates to the master control logic 208 the location of some destination registers in the register file 112 on the processing module 102′. These are the registers that will be used to receive the results. These may be indicated in a similar manner to the source registers, for example.

In embodiments, the shader software 110′ does not have to signal to the ray engine 104′ for each individual ray descriptor or block, but rather just executes one “uber instruction” which indicates the locations of the ray descriptors of a task, e.g. by communicating a starting register address for the first ray descriptor of the task, or such like. This uber instruction is implemented as a single machine code instruction defined in the instruction set of the processing apparatus 106 (hence in embodiments the processing apparatus 106 may also be modified compared to that of FIG. 1). When executed, it sends a corresponding “uber” command to get control logic 208 on the ray engine 104′ providing all the information the ray engine 104′ will need to pull the ray descriptions of one batch from the register file 112 and push the results back again.

More generally however, any means of informing the master control logic 208 on the ray engine 104′ of the source locations of the ray descriptors in the register file 112 could be used, and similarly for the destination registers.

Once the shader software 110′ has assigned enough batches of ray descriptors to the ray engine 104′ to fill the ray store 122 (or at least such that there is not enough room for the batch of a whole new task until some more blocks have been freed), the shader software 110′, or some portion thereof, may enter a dormant state (“go to sleep”) where it simply monitors for a wake-up signal from the ray engine 104′. In embodiments, each batch of ray descriptors is the responsibility of a respective task run on the processing apparatus 106 of the processing module 102, and each task may enter the dormant state once it has assigned its respective batch of ray descriptors to the ray engine 104′ in the manner described above. Each task may monitor for a wake-up following the completion of its own respective batch by the ray engine 104′. In other words the task is de-scheduled which means that it will not be selected by the scheduler to be executed while in that state. In embodiments a task may do nothing else than minor for the wake-up signal while in the dormant state. When no new tasks can begin because the ray store 122 does not have enough free space, the shader software 110′ is running no active tasks, and may be doing nothing other than the monitoring. However in alternative implementations it is not excluded that one or more other, background processes could be going on while in the dormant state.

When the master control logic 208 in the ray engine 104′ receives the indication of the source and destination registers for a batch of rays (e.g. those of a given task), it holds an indication of the locations in the register map 201. Based thereon, the master control logic 208 in the ray engine 104′ then uses the knowledge of these locations to autonomously pull each of the ray descriptors of the batch from the indicated source register in the register file 112 on the via the interface circuitry 114, 116 and the special path 203 onboard the processing module 102′ (autonomously at least in that it does not need to be controlled individually by the processing module 102′ to allow each individual register read). The processing module 102′ does not have to individually push each descriptor to the ray engine 104′.

The master control logic 208 also autonomously allocates the memory space for the batch in the ray store 122, and stores the ray descriptors of the batch therein (note that the allocation happens before reading the source registers in order to provide somewhere to store the read data in the ray engine 104′). Particularly, the master control logic 208 allocates the memory space for the batch in blocks, where each block corresponds to a different subset of the ray IDs in the range of the batch (e.g. of a given task). Preferably each block is a continuous subrange of the ray IDs. Preferably the blocks are exclusive of one another. Allocating in blocks means that the allocation table 119′ now records, for each unit of memory address space (each address or address range according to whatever address resolution being used), not only the fact of being allocated/unallocated and which batch (or task) that unit of address space is allocated to, but also which bock within the batch that unit of memory space is allocated to.

The ray-tracing circuitry 120 takes the ray descriptors from the ray store 122 and processes them as before. The ray-tracing circuitry 120 per se may be unmodified compared to FIG. 1, at least in this respect. However, the master control logic 208 on the ray engine 104′ is configured to monitor for when the ray-tracing circuitry 120 has completed the processing all the rays of any individual block of ray descriptors, rather than waiting for the processing of a whole batch (e.g. of a whole task) to be finished. In response to detecting the completion of any individual block (rather than batch), the master control logic 208 of the ray engine 104′ pushes the respective hit results back to the shader software 110′ on the processing module 102′ (via the interface logic 116, 114). The master control logic 208 then deallocates the block in the memory or the ray store 122 (by changing the corresponding record in the memory allocation table 119′ ). Thus an individual block can be freed without waiting for the whole batch (e.g. of a whole task) to which that block belongs in order to finish.

In embodiments, the pushing of the results may be done by pushing the results to the indicated destination registers in the register file 112 via the special path 203, and signalling to the shader software 110′ (e.g. the relevant task) on the processing apparatus 106 to indicate that the results are now available, e.g. via an interrupt signal or similar. This may be the same mechanism as used to wake up the task in the conventional arrangement. The destination registers are those which the shader software 110′ (e.g. task) indicated when assigning the batch, and which the master control logic 208 in the ray store 104′ knows because it held them in its register map 201. Alternatively it is not excluded in other embodiments that the results could be pushed or sent via some other means, such as via a general purpose port. Either way, if the software 110′ has gone to sleep, then in embodiments the signal from the master control logic 208 on the ray engine 104′, indicating that a block has been completed, may wake up the shader software 110′ or some portion thereof. E.g. the task to which the block belongs may be woken up. In embodiments, the shader or task may not be woken up until the last block of a given batch is completed as it may be desirable or required to process the results of a given task together. Alternatively it is not excluded in all possible implementations that a shader or task could be woken up after one or more blocks of a batch are completed in order to begin processing results before the entire batch is finished. Either way, the logic 208 on the ray engine 104′ now tracks ray-store storage in blocks rather than tasks.

If the system 100 was stalled unable to begin processing a new batch of ray descriptors (of a new task) by the ray engine 104′ because the ray store 122 was full (or did not have enough free blocks for a new batch, e.g. of a new task), but then subsequently enough blocks now become available to accommodate a new batch (e.g. of a new task), then the ray engine 104′ can begin processing a new batch. In embodiments the master control logic 208 on the ray engine 104′ monitors the fullness of the ray store 122 and determines when it can begin processing a new batch. In embodiments the shader software 110′ on the processing module 102′ sends a command per batch (e.g. the task responsible for each batch sends the command). E.g. this may be the command issued by a given uber instruction, as discussed earlier. The ray engine 104′ may comprise a command buffer (not shown) which can locally buffer one or more pending commands currently unable to be processed due to the fullness of the ray store 122 (i.e. when it currently does not have enough free blocks to start a new batch, e.g. of a new task). The master control logic 208 in the ray engine 104′ will be unable to use the ray tracing circuitry 120 to process a locally-buffered command for a new batch/task until it can allocate the desired blocks in the ray store 122. However, the possibility of other implementations is not excluded, e.g. where the software 110′ on the processing module 102′ monitors the fullness of the ray store based on signals from the logic 208 on the ray engine 104′, and stops assigning new batches of ray descriptors until enough space is available.

In embodiments, the block size may be configurable. I.e. the number of ray descriptors into which the batch of each task is divided (the number or rays per subset) may be configurable, e.g. to select between a block size of 8 or 16 rays. In embodiments this parameter is configurable via a RTL (register transfer language) that is given to customers of the processor design. E.g. the RTL may include a “define” command that enables the customer to set the block size. The customer will synthesize the RTL with the “define” set to 8, for example, and what will come out will be the netlist (gatelist) of the circuitry that they can then go on to send for manufacturing.

Alternatively the block size could be configurable by other means, such as a fuse latch. Or in other alternative implementations, the block size may be programmable, e.g. via a programmable register (not shown) in the ray engine 104′, into which the bock size value may be written by the shader software 110′ running on the processing module (via the interface 114, 116) or by the control logic 108′ on the ray engine 104′, or either, depending on implementation. More generally, “configurable” can refer to any setting that can be adjusted before the design is finalized or built, and “programmable is anything that can be changed in dynamically while the designed system is running.

By whatever means set, in embodiments the same configured block size will be used for all the blocks of at least one batch (e.g. of at least one task). Alternatively it is not excluded that the possibility of finer control of block size within a batch could be provided.

In yet further alternative or additional implementation, the batch size (e.g. rays per task) could be configurable or programmable, and/or the size of the ray store 122 could be configurable or programmable, e.g. in any of the same ways described above for the block size. In one particular envisaged architecture however the batch size is not configurable nor programmable.

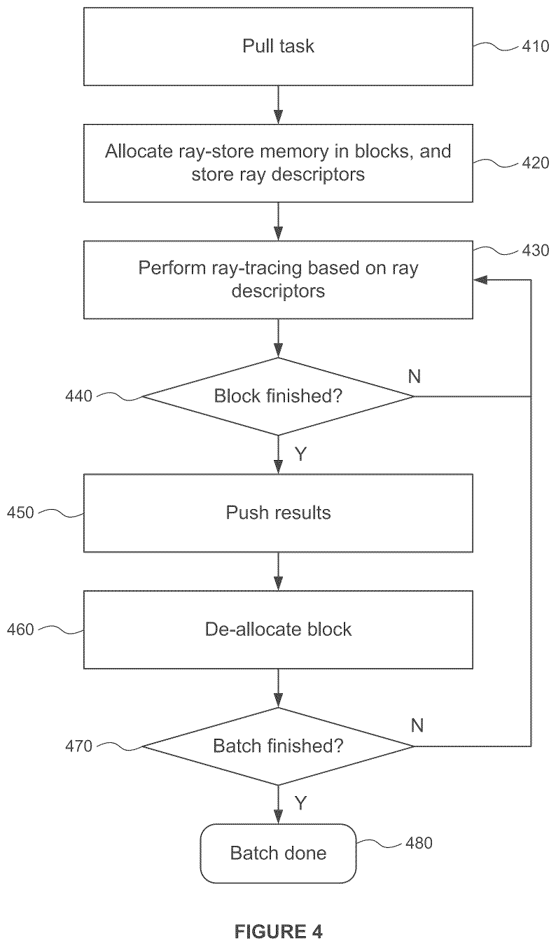

FIG. 4 shows a method which may be performed by a modified ray engine 104′ in accordance with embodiments disclosed herein, whether configured quite as described in relation to FIG. 2 or otherwise.

At step 410 the ray engine 104′ pulls a batch of ray descriptors (e.g. of a corresponding task) from the processing module 102′. This may comprise receiving an indication of some source registers and destination registers of the register file 112 of the processing module 102′, storing this information in the register map 201, then pulling the ray descriptors of the batch from the indicated source registers.

At step 420 the ray engine 104′ allocates memory space in the ray store 122 and stores the ray descriptors therein. This may comprises allocating address ranges to blocks in the memory allocation table 119′.

Steps 420-430 may be performed for a plurality of batches (e.g. of a plurality of corresponding tasks) such that the ray descriptors of the plurality of tasks are stored in the ray store 122.

At step 430, the ray engine 104′ processes the rays—i.e. performs ray tracing of the respective modelled rays based on the ray descriptors, thereby generating a hit result for the modelled ray corresponding to each descriptor.

At step 440 the ray engine 104′ monitors the completion of rays and determines whether a whole block of rays has been completed. E.g. a block could be 8 or 16 rays (or rather ray descriptors). If not yet, the ray engine 104′ continues processing rays as in step 430.

If so however, then at step 450, the ray engine 104′ pushes the results of the block back to the processing module to be processed by the shader software 110′ (e.g. the relevant task). This may comprise writing the results to the respective destination registers as recorded in the register map 201 from the time of the batch being assigned. Alternatively or additionally, this step may comprise sending a wake-up signal to the processing module 102′ to wake up the shader software 110′ or a relevant portion thereof (e.g. the corresponding task that assign the batch in the first place and then went to sleep).

At step 460 the ray engine 104′ then deallocates the memory space in the ray store 122 that was allocated to the block that has just been completed. This may comprise updating the memory allocation table 119′.

At step 470 the ray engine monitors for the completion of an entire batch (e.g. of an entire task). If not yet complete, such that at least one ray descriptor of at least one block of a given batch remains to be processed, then the ray engine 104′ continues processing rays as in step 430.

If a whole batch (e.g. of a given task) is detected to be completed, then the batch is done at step 480. This may involve signalling to the processing module 102′, e.g. to wake up the shader software 110′ or a portion therefore (e.g. the relevant task) to process the results. This may be applicable in embodiments where the software or task is not woken up in response to an individual block. Alternatively in other possible implementations, the ray engine 104′ may not need to signal to the processing module 102′ when a batch is done, if the shader software 110 does not go to sleep and/or is separately keeping track of which blocks have been completed.

Note that FIG. 4 is somewhat schematized and the streps do not necessarily all have to happen in in linear order as shown. For example, steps 450-460 could be being performed for one block while step 430 is congoing for other blocks, and/or steps 410-420 could be being performed for a new batch (e.g. of a new task) while other steps such as 430, 440, 450-460 and/or 470-480 are ongoing for existing batches (e.g. of existing tasks).

Further, it will be appreciated that the arrangement of FIG. 2 and method of claim 4 are given only by way of example, albeit being illustrative of preferred embodiments. In alternative embodiments, it is not excluded that the principle of allocating and deallocating rays in blocks rather than batches or tasks could be implemented with the control logic on the ray engine still a slave to the processing module 102, under control of the shader software 110; and/or with the use of individual instructions to read and write individual ray descriptors, rather than through the use of an “uber instruction”.

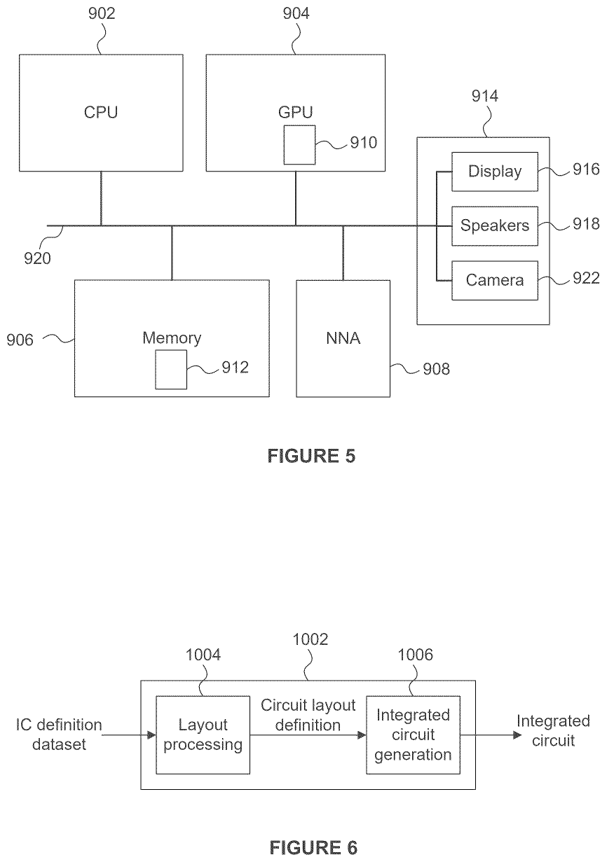

FIG. 5 shows a computer system in which the graphics processing systems described herein may be implemented. The computer system comprises a CPU 902, a GPU 904, a memory 906, a neural network accelerator (NNA) 908 and other devices 914, such as a display 916, speakers 918 and a camera 922. A processing block 910 (corresponding to processing block 100′) is implemented on the GPU 904. In other examples, one or more of the depicted components may be omitted from the system, and/or the processing block 910 may be implemented on the CPU 902 or within the NNA 908. The components of the computer system can communicate with each other via a communications bus 920. A store 912 (which may or may not correspond, in whole or in part, to store 110) is implemented as part of the memory 906.

The processor and system of FIGS. 2 and 5 are shown as comprising a number of functional blocks. This is schematic only and is not intended to define a strict division between different logic elements of such entities. Each functional block may be provided in any suitable manner. It is to be understood that intermediate values described herein as being formed by a processor need not be physically generated by the processor at any point and may merely represent logical values which conveniently describe the processing performed by the processor between its input and output.

The processors described herein may be embodied in hardware on an integrated circuit. The processors described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a processor configured to perform any of the methods described herein, or to manufacture a processor comprising any apparatus described herein. An integrated circuit definition dataset may be, for example, an integrated circuit description.

Therefore, there may be provided a method of manufacturing, at an integrated circuit manufacturing system, a processor as described herein. Furthermore, there may be provided an integrated circuit definition dataset that, when processed in an integrated circuit manufacturing system, causes the method of manufacturing a processor to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a processor will now be described with respect to FIG. 6.

FIG. 6 shows an example of an integrated circuit (IC) manufacturing system 1002 which is configured to manufacture a processor as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a processor as described in any of the examples herein), process the IC definition dataset, and generate an IC according to the IC definition dataset (e.g. which embodies a processor as described in any of the examples herein). The processing of the IC definition dataset configures the IC manufacturing system 1002 to manufacture an integrated circuit embodying a processor as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processor without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 6 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 6, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A processor, comprising:
a processing module comprising a register file and processing apparatus, the processing apparatus comprising one or more execution units, wherein the processing apparatus is arranged to execute software and thereby operate on values held in the register file; and
a ray engine comprising a ray store and ray-tracing circuitry, wherein the ray store is implemented in memory that requires address space to be allocated for use and de-allocated to allow re-use;
wherein the ray-engine further comprises control circuitry arranged to receive a plurality of batches of ray descriptors supplied from the processing module, each batch comprising respective ray descriptors of a plurality of modelled rays, and to allocate ray descriptors to address space of the ray store in blocks of ray descriptors, each block being a subset of the ray descriptors in the batch, and store each block in the allocated address space;
wherein for each batch of ray descriptors, the ray-tracing circuitry is configured to perform processing of each of the rays of the batch based on the respective ray descriptors stored in the ray store and thereby generate respective hit results, the processing comprising ray-tracing; and
wherein, the control circuitry is configured, for each block, to deallocate the memory allocated to the block in response to the processing of all the rays in the block being finished by the ray-tracing engine.

2. The processor of claim 1, wherein the control circuitry in the ray engine is configured to perform said receiving of the plurality of batches of ray descriptors by pulling each of the batches from the processing module.

3. The processor of claim 2, wherein the control circuitry in the ray engine is configured to perform said receiving of the plurality of batches of ray descriptors by pulling the ray descriptors of each of the batches from the register file of the processing module.

4. The processor of claim 2, wherein the software arranged to run on the processing apparatus of the processing module is arranged to cause the control circuitry in the ray engine to perform said pulling, by the software comprising one or more instructions configured to:
for each batch of ray descriptors, send to the control circuitry in the ray engine an indication of locations of source registers holding the respective ray descriptors of the rays of the batch in the register file of the processing module, thereby causing the control circuitry in the ray engine to record the locations of the source registers in a register map in the ray engine and pull the respective ray descriptors from the register file of the processing module, the control circuitry in the ray engine being configured to perform said pulling by pulling from the locations of the source registers as recorded in the register map.

5. The processor of claim 1, wherein the control circuitry in the ray engine is configured so as, for each block, to send the hit respective results of the rays of the block to the processing module.

6. The processor of claim 5, wherein the control circuitry in the ray engine is configured to perform said sending by storing the respective hit results in the register file of the processing module.

7. The processor of claim 6, wherein the control circuitry in the ray engine is configured to perform said storing by pushing the respective hit results to the register file in the processing module.

8. The processor of claim 4, wherein:
the control circuitry in the ray engine is configured so as, for each block, to send the hit respective results of the rays of the block to the processing module;
the control circuitry in the ray engine is configured to perform said sending by storing the respective hit results in the register file of the processing module; and
the one or more instructions are further configured to send, to the control circuitry in the ray engine, an indication of locations of respective destination registers in the register file for receiving the hit results of the rays of the respective ray descriptors; and the control circuitry in the ray engine is configured to record the locations of the destination register in the register map, and perform said sending by sending the hit results to the respective destination registers.

9. The processor of claim 4, wherein said one or more instructions comprise a single machine code instruction per batch of ray descriptors.

10. The processor of claim 1, wherein the control circuitry in the ray engine is configured as a master to the processing module.

11. The processor of claim 1, wherein
each batch corresponds to a range of ray IDs of N respective ray descriptors, the ray store can hold a maximum of M×N ray descriptors, each block is of size B ray descriptors, where M, N and B are integers greater than one; and
the software arranged to run on the processing apparatus of the processing module is configured so as, after M batches have been received by the ray engine for processing, to send a further batch when ray store still holds M unfinished tasks but k blocks are completed, where kB>=N, and k is an integer greater than one.

12. The processor of claim 1, wherein the software arranged to execute on the processing module comprises a plurality of tasks, each being configured to supply a corresponding one of the batches of ray descriptors to the ray engine.

13. The processor of claim 12, wherein each task is configured to enter a dormant state after supplying its corresponding batch to the ray engine, and to wake up again and process the respective hit results of the batch in response to a completion signal from the control circuitry of the ray engine signalling that the processing of all the rays in the batch has been completed.

14. The processor of claim 1, wherein the control circuitry in the ray engine is configured to:
determine when the ray store is unable to accommodate any further batches, and in response pause the processing of any further batches of ray descriptors; and
determine when enough blocks have subsequently been freed to accommodate a further batch, and in response to process at least one further batch of ray descriptors.

15. The processor of claim 1, wherein the control circuitry in the ray engine is configured such that the blocks are of configurable or programmable size.

16. The processor of claim 1, wherein each ray descriptor has a respective ray ID, and each block is subset of the descriptors with contiguous ray IDs.

17. The processor of claim 1, wherein the ray-tracing circuitry is fixed-function ray-tracing hardware.

18. A method comprising, at a ray engine:
receiving a plurality of batches of ray descriptors supplied from a processing module, each batch comprising respective ray descriptors of a plurality of modelled rays;
allocating address space in a ray store of the ray engine for each batch of ray descriptors by allocating ray descriptors to address space of the ray store in blocks of ray descriptors, each block being a subset of the ray descriptors in the batch and storing each block in the allocated address space; and
for each batch of ray descriptors, performing processing of each of the rays of the batch based on the respective ray descriptors stored in the ray store and thereby generating respective hit results, the processing comprising ray-tracing;
wherein the method further comprises, for each block, deallocating the memory allocated to the block in response to the processing of all the rays in the block being finished.

19. A non-transitory computer readable storage medium having stored thereon computer readable code configured to cause the method as set forth in claim 18 to be performed when the code is run.

20. A non-transitory computer readable storage medium having stored thereon a computer readable dataset description that, when processed in an integrated circuit manufacturing system, causes the integrated circuit manufacturing system to manufacture an integrated circuit embodying a processor comprising:
a processing module comprising a register file and processing apparatus, the processing apparatus comprising one or more execution units, wherein the processing apparatus is arranged to execute software and thereby operate on values held in the register file; and
a ray engine comprising a ray store and ray-tracing circuitry, wherein the ray store is implemented in memory that requires address space to be allocated for use and de-allocated to allow re-use;
wherein the ray-engine further comprises control circuitry arranged to receive a plurality of batches of ray descriptors supplied from the processing module, each batch comprising respective ray descriptors of a plurality of modelled rays, and to allocate ray descriptors to address space of the ray store in blocks of ray descriptors, each block being a subset of the ray descriptors in the batch, and store each block in the allocated address space;
wherein for each batch of ray descriptors, the ray-tracing circuitry is configured to perform processing of each of the rays of the batch based on the respective ray descriptors stored in the ray store and thereby generate respective hit results, the processing comprising ray-tracing; and
wherein, the control circuitry is configured, for each block, to deallocate the memory allocated to the block in response to the processing of all the rays in the block being finished by the ray-tracing engine.
